(19) United States
(12) Patent Application Publication
(10) Pub. No.: US 2014/0344070 A1
(43) Pub. Date: Nov. 20, 2014

(54) CONTEXT-AWARE VIDEO PLATFORM SYSTEMS AND METHODS

(71) Applicant: RealNetworks, Inc., Seattle, WA (US)

(72) Inventors: Joel JACOBSON, Seattle, WA (US); Philip SMITH, Seattle, WA (US); Phil AUSTIN, Maple Valley, WA (US); Senthil VAIYAPURI, Federal Way, WA (US); Satish KILARU, Seattle, WA (US)

(21) Appl. No.: 14/448,993

(22) Filed: Jul. 31, 2014

Related U.S. Application Data
(62) Division of application No. 13/897,213, filed on May 17, 2013.
(60) Provisional application No. 61/648,538, filed on May 17, 2012.

(51) Int. Cl. G06Q 30/02

(52) U.S. Cl. CPC G06Q 30/0269
USPC 705/14.66

(57) ABSTRACT

A video-platform server may obtain and provide context-specific metadata to remote playback devices, including identifying advertising campaigns and/or games that match one or more assets (e.g., actors, locations, articles of clothing, business establishments, or the like) that are depicted in or otherwise associated with a given video segment.

### CROSS-REFERENCE TO RELATED APPLICATIONS

This application claims the benefit of priority to the following applications:

Provisional Patent Application No. 61/648,538, filed May 17, 2012 under Attorney Docket No. REAL-2012389, titled “CONTEXTUAL ADVERTISING PLATFORM WORKFLOW SYSTEMS AND METHODS”, and naming inventors Joel Jacobson et al. and

Provisional Patent Application No. 61/658,766, filed Jun. 12, 2012 under Attorney Docket No. REAL-2012395, titled “CONTEXTUAL ADVERTISING PLATFORM DISPLAY SYSTEMS AND METHODS”, and naming inventors Joel Jacobson et al.

The above-cited applications are hereby incorporated by reference, in their entireties, for all purposes.

### FIELD

The present disclosure relates to the field of computing, and more particularly, to a video platform server that obtains and serves contextual metadata to remote playback clients.

### BACKGROUND

In 1995, RealNetworks of Seattle, Wash. (then known as Progressive Networks) broadcast the first live event over the Internet, a baseball game between the Seattle Mariners and the New York Yankees. In the decades since, streaming media has become increasingly ubiquitous, and various business models have evolved around streaming media and advertising. Indeed, some analysts project that spending on on-line advertising will increase from $41 B in 2012 to almost $68B in 2015, in part because many consumers enjoy consuming streaming media via laptops, tablets, set-top boxes, or other computing devices that potentially enable users to interact and engage with media in new ways.

For example, in some cases, consuming streaming media may give rise to numerous questions about the context presented by the streaming media. In response to viewing a given scene, a viewer may wonder “who is that actor?”, “what is that song?”, “where can I buy that jacket?”, or other like questions. However, existing streaming media services may not provide facilities for advertisers and content distributors to manage contextual metadata and offer contextually relevant information to viewers as they consume streaming media.

### BRIEF DESCRIPTION OF THE DRAWINGS

FIG. 1 illustrates a contextual video platform system in accordance with one embodiment.

FIG. 2 illustrates several components of an exemplary video-platform server in accordance with one embodiment.

FIG. 3 illustrates an exemplary series of communications between video-platform server, media-playback device, tag-editor device, and advertiser device in accordance with one embodiment.

FIG. 4 illustrates exemplary game and advertising-campaign specifications, in accordance with one embodiment.

FIG. 5 illustrates a routine for providing a contextual video platform, such as may be performed by a video-platform server in accordance with one embodiment.

FIG. 6 illustrates a subroutine for determining asset time-line data associated with a given media presentation, such as may be performed by a video-platform server in accordance with one embodiment.

FIG. 7 illustrates a subroutine for serving contextual advertising metadata associated with a given video segment, such as may be performed by a video-platform server in accordance with one embodiment.

FIG. 8 illustrates an exemplary tagging user interface for creating and/or editing asset tags associated with a video segment, such as may be provided by video-platform server for use by a tag-editor device in accordance with one embodiment.

FIG. 9 illustrates an exemplary context-aware media-rendering user interface, such as may be provided by video-platform server and generated by media-playback device in accordance with one embodiment.

### DESCRIPTION

In various embodiments as described herein, a video-platform server may obtain and provide context-specific metadata to remote playback devices, including identifying advertising campaigns and/or games that match one or more assets (e.g., actors, locations, articles of clothing, business establishments, or the like) that are depicted in or otherwise associated with a given video segment.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

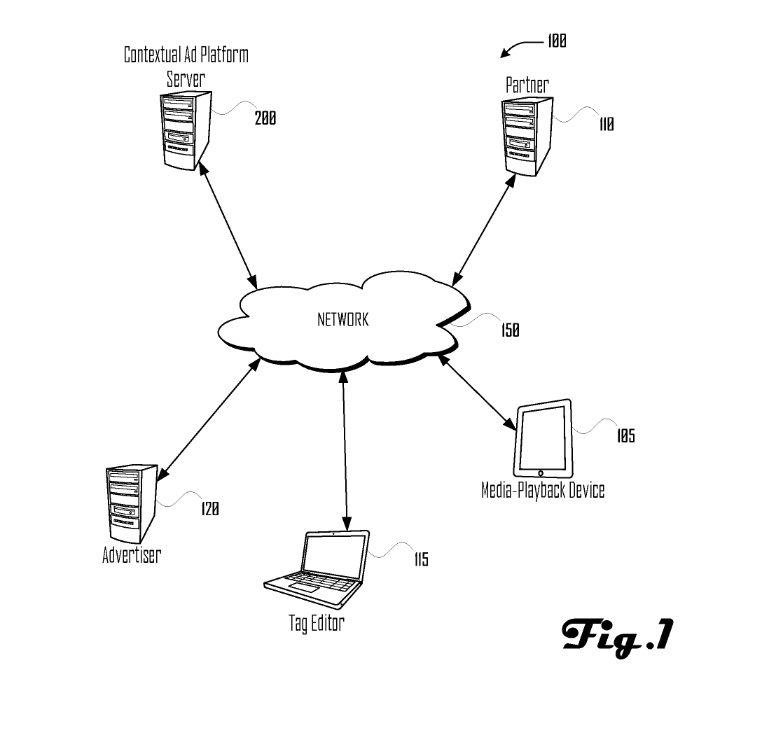

FIG. 1 illustrates a contextual video platform system in accordance with one embodiment. In the illustrated system, video-platform server 200, media-playback device 105, partner device 110, tag-editor device 115, and advertiser device 120 are connected to network 150.

In various embodiments, video-platform server 200 may comprise one or more physical and/or logical devices that collectively provide the functionalities described herein. In some embodiments, video-platform server 200 may comprise one or more replicated and/or distributed physical or logical devices.

In some embodiments, video-platform server 200 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

In various embodiments, partner device 110 may represent one or more devices operated by a content producer, owner, distributor, and/or other like entity that may have an interest in promoting viewer engagement with streamed media. In various embodiments, video-platform server 200 may provide facilities by which partner device 110 may add, edit, and/or otherwise manage asset definitions and context data associated with video segments.

In various embodiments, advertiser device 120 may represent one or more devices operated by an advertiser, sponsor, and/or other like entity that may have an interest in promoting viewer engagement with streamed media. In various embodiments, video-platform server 200 may provide facilities by which partner device 110 may add, edit, and/or otherwise manage advertising campaigns and/or asset-based games.

In various embodiments, network 150 may include the Internet, a local area network (“LAN”), a wide area network (“WAN”), a cellular data network, and/or other data network. In various embodiments, media-playback device 105 and/or tag-editor device 115 may include a desktop PC, mobile phone, laptop, tablet, or other computing device that is capable of connecting to network 150 and rendering media data as described herein.

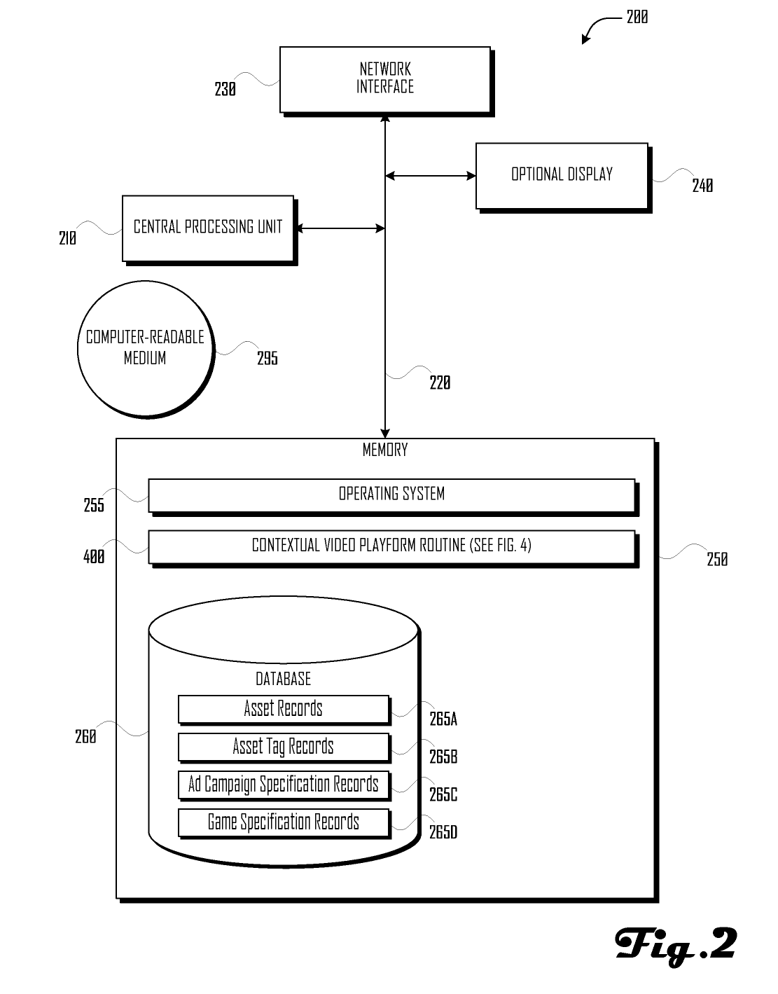

FIG. 2 illustrates several components of an exemplary video-platform server in accordance with one embodiment. In some embodiments, video-platform server 200 may include many more components than those shown in FIG. 2. However, it is not necessary that all of these generally conventional components be shown in order to disclose an illustrative embodiment.

Video-platform server 200 includes a bus 220 interconnecting components including a processing unit 210; a memory 250; optional display 240; input device 245; and network interface 230.

In various embodiments, input device 245 may include a mouse, track pad, touch screen, haptic input device, or other pointing and/or selection device.

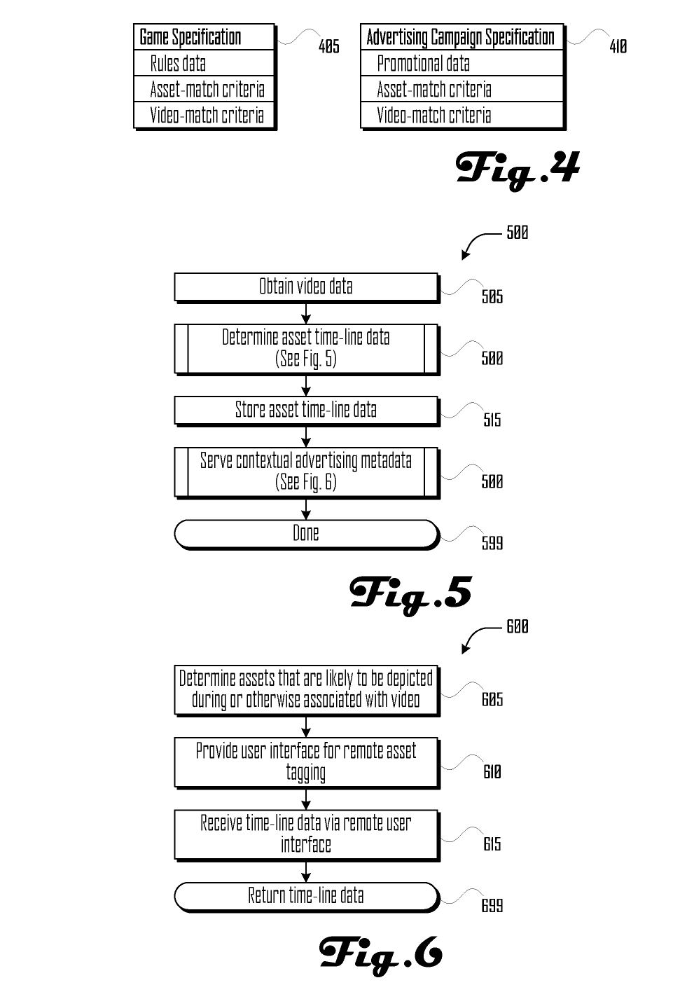

Memory 250 generally comprises a random access memory (“RAM”), a read only memory (“ROM”), and a permanent mass storage device, such as a disk drive. The memory 250 stores program code for a routine 500 for providing a contextual video platform (see FIG. 5, discussed below). In addition, the memory 250 also stores an operating system 255.

These and other software components may be loaded into memory 250 of video-platform server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

Memory 250 also includes database 260, which stores records including records 265A-D.

In some embodiments, video-platform server 200 may communicate with database 260 via network interface 230, a storage area network (“SAN”), a high-speed serial bus, and/or via the other suitable communication technology.

In some embodiments, database 260 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

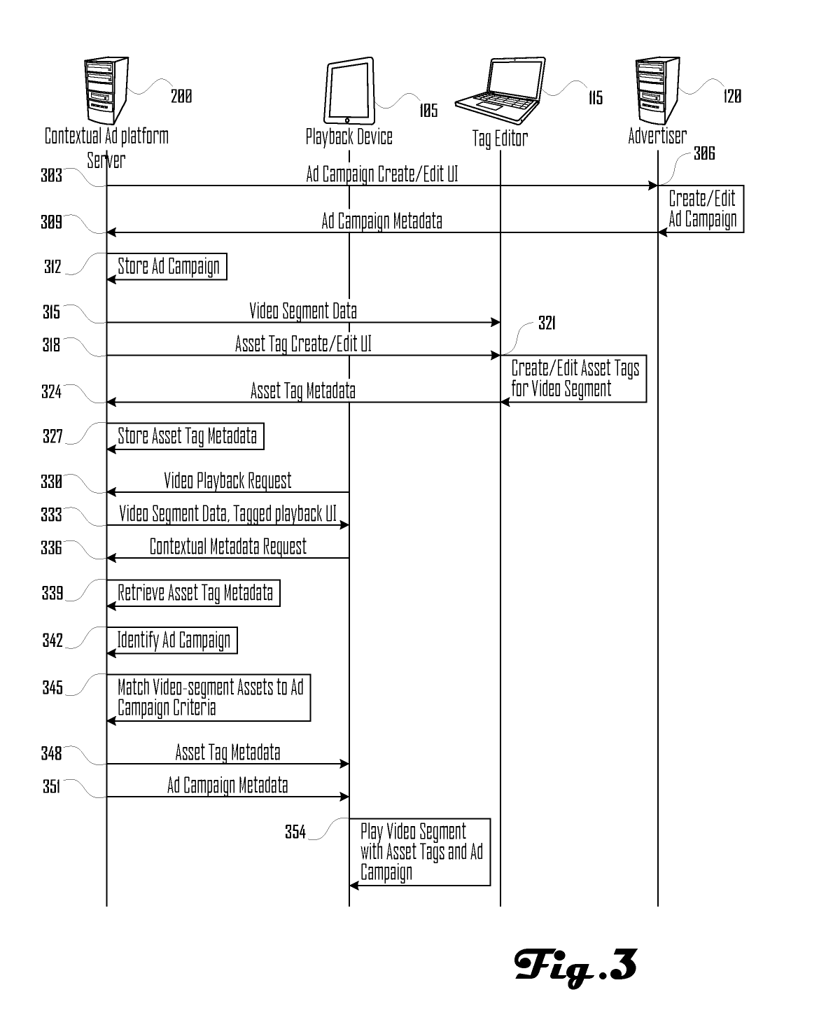

FIG. 3 illustrates an exemplary series of communications between video-platform server 200, media-playback device 105, tag-editor device 115, and advertiser device 120 in accordance with one embodiment. Prior to the illustrated sequence of communications, video-platform server 200 obtained from partner device 110 video data corresponding to one or more video segments (not shown).

Beginning the illustrated sequence of communications, video-platform server 200 sends to advertiser device 120 a user interface 303 for creating and/or editing an advertising campaign. Advertiser device 120 uses the provided user interface to create and/or edit 306 an advertising campaign associated with one or more video segments. Video-platform server 200 obtains metadata 309 corresponding to the created and/or edited advertising campaign and stores 312 the metadata (e.g., in database 260). For example, in one embodiment, video-platform server 200 may store a record including data similar to that shown in exemplary advertising campaign specification 410 (see FIG. 4, discussed below).

At some point before, during, or after obtaining metadata 309, video-platform server 200 sends to tag-editor device 115 video data 315 corresponding to at least a portion of a video segment. Video-platform server 200 also sends to tag-editor device 115 a user interface 318 for creating and/or editing asset tags associated with the video segment. For example, in one embodiment, video-platform server 200 may provide a user interface such as tagging user interface 800 (see FIG. 8, discussed below).

As the term is used herein, “assets” refer to objects, items, actors, and other entities that are depicted in or otherwise associated with a video segment. For example, within a given 30-second scene, the actor “Art Arterton” may appear during the time range from 0-15 seconds, the actor “Betty Bing” may appear during the time range 12-30 seconds, the song “Pork Chop” may play in the soundtrack during the time range from 3-20 seconds, and a particular laptop computer may appear during the time range 20-30 seconds. In various embodiments, some or all of these actors, songs, and objects may be considered “assets” that are depicted in or otherwise associated with the video segment.

Using the provided tag-editing user interface, tag-editor device 115 creates and/or edits 321 asset tags corresponding to assets that are depicted in or otherwise associated with the video segment. Video-platform server 200 obtains metadata 324 corresponding to the created and/or edited assets and stores 327 the metadata (e.g., in database 260). For example, in one embodiment, video-platform server 200 may store a record including data similar to that shown in exemplary game specification 405 (see FIG. 4, discussed below).

At some point after assets have been tagged in a video segment and an advertising campaign created, media-playback device 105 sends to video-platform server 200 a request 330 to play back the video segment. Video-platform server 200 retrieves (not shown) and sends 333 to media-playback device 105 renderable media data corresponding to the video segment, as well as executable code and/or metadata for an asset-context-enabled playback user interface.

Typically, renderable media data includes computer-processable data derived from a digitized representation of a piece of media content, such as a video or other multimedia presentation. The renderable media data send to media-playback device 105 may include less than all of the data required to render the entire duration of the media presentation. For example, in one embodiment, the renderable media data may include a segment (e.g. 30 or 60 seconds) within a longer piece of content (e.g., a 22 minute video presentation).

In the course or preparing to render the media data, media-playback device 105 sends to video-platform server 200 a request 336 for contextual metadata associated with a given segment of the media presentation. In response, video-platform server 200 retrieves 339 the requested metadata, including one or more asset tags corresponding to assets that are depicted in or otherwise associated with the media segment.

In addition, video-platform server 200 identifies 342 at least one advertising campaign that is associated with the media presentation and matches 345 at least one asset depicted in or otherwise associated with the media segment with at least one asset-match criteria of the advertising campaign. For example, in one embodiment, video-platform server 200 determines that the media segment in question satisfies at least one video-match criteria of at least one previously-defined advertising campaign.

Video-platform server 200 sends to media-playback device 105 asset tag metadata 348 corresponding to one or more assets that are depicted in or otherwise associated with the media segment, as well as advertising campaign metadata 351 corresponding to the identified advertising campaign. For example, in one embodiment, video-platform server 200 may send a data structure similar to the following.

{

“Asset ID”: “d13b7e51ec93”,
“Media ID”: “5d0b431d63f1”,
“Asset Type”: “Person”,
“AssetControl”: “/asset/d13b7e51ec93/thumbnail.jpg”,
“Asset Context Data”: “http://en.wikipedia.org/wiki/Art_Arterton”,
“Time Start”: 15,
“Time End”: 22.5,
“Coordinates”: [ 0.35, 0.5 ]

}

Using the data thereby provided, media-playback device 105 plays 354 the video segment, including presenting promotional content and asset metadata about assets that are currently depicted in or otherwise associated with the media segment.

FIG. 4 illustrates exemplary game and advertising-campaign specifications, in accordance with one embodiment. In various embodiments, records corresponding to such specifications may be stored in database 260.

Exemplary game specification 405 includes rules data, one or more asset-match criteria, and one or more video-match criteria.

For example, in one embodiment, rules data may specify various aspects, such as some or all of the following about a given game:

that the game is of a certain type (e.g., a “scavenger hunt”-type asset-matching game);

that the game has one or more conditions (e.g., find at least 5 assets that satisfy the asset-match criteria) that must be satisfied to “win” the game;

that the game has a certain reward (e.g., 500 points) associated with “winning” the game;

and the like. In some embodiments, asset-match criteria may specify one or more specific assets (e.g., the asset having an ID of 12345). In other embodiments, asset-match criteria may specify one or more classes of asset (e.g., assets of type “Product:Clothing”).

In some embodiments, video-match criteria may specify one or more videos or media presentations that are associated with the specified game and during which the specified game may be played.

Exemplary advertising campaign specification 410 includes promotional data, one or more asset-match criteria, and one or more video-match criteria.

FIG. 5 illustrates a routine 500 for providing a contextual video platform, such as may be performed by a video-platform server 200 in accordance with one embodiment.

In block 505, routine 500 obtains, e.g., from partner device 110, renderable media data.

In subroutine block 600, routine 500 calls subroutine 600 (see FIG. 6, discussed below) to obtain asset time-line data corresponding to a number of assets that are depicted in or otherwise associated with the renderable media data obtained in block 505.

In block 515, routine 500 stores, e.g., in database 260, the asset time-line data (as obtained in subroutine 600).

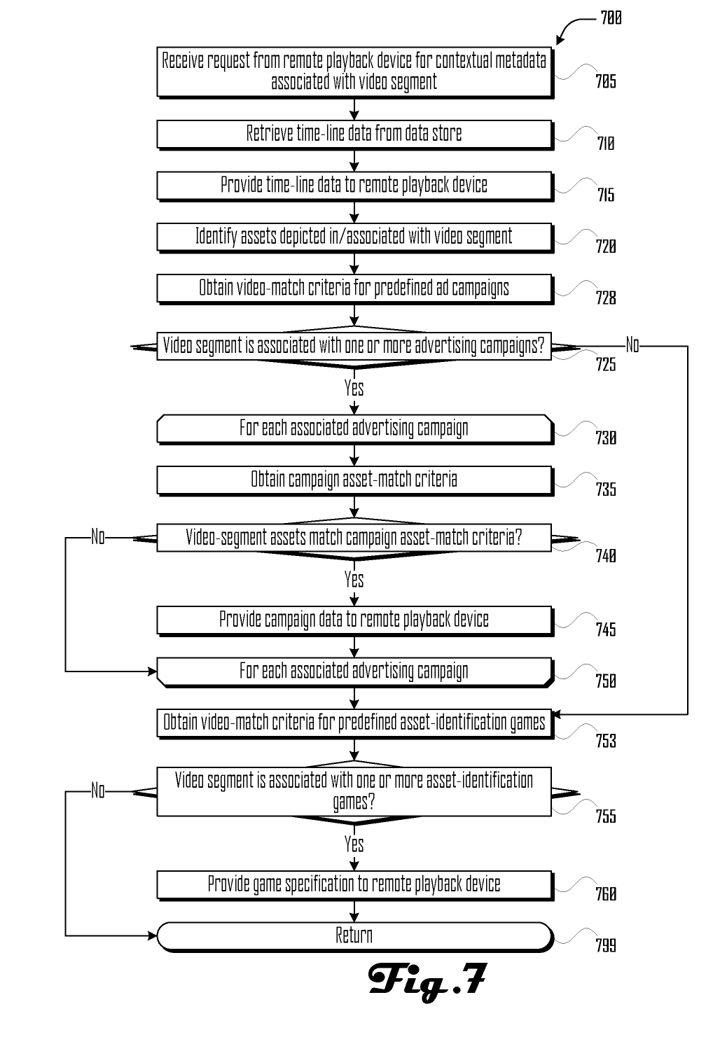

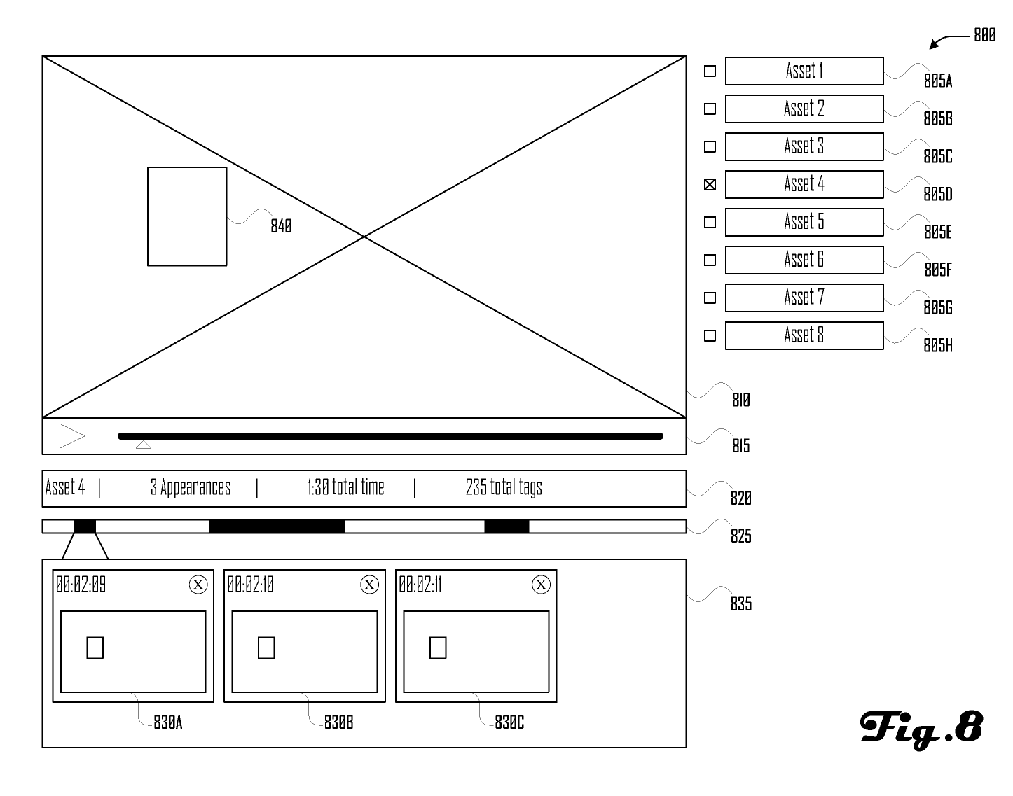

In subroutine block 700, routine 500 calls subroutine 700 (see FIG. 7, discussed below) to serve contextual advertising metadata to remote playback devices (e.g. media-playback device 105).

Routine 500 ends in ending block 599.

FIG. 6 illustrates a subroutine 600 for determining asset time-line data associated with a given media presentation, such as may be performed by a video-platform server 200 in accordance with one embodiment.

In block 605, subroutine 600 determines one or more assets that are likely to be depicted during or to be otherwise associated with the given media presentation. For example, in one embodiment, subroutine 600 may identify a plurality of assets that correspond to cast members of the given media presentation.

In block 610, subroutine 600 provides a user interface that may be used (e.g., by tag-editor device 115) for remotely tagging assets within the given media presentation. For example, in one embodiment, subroutine 600 may provide a user interface similar to tagging user interface 800 (see FIG. 8, discussed below).

In block 615, subroutine 600 receives time-line data via the remote user interface provided in block 610. For example in some embodiments, the asset time-line data may include a plurality of data structures including asset entries having asset metadata such as some or all of the following.

{

“Asset ID”: “d13b7e51ec93”,
“Media ID”: “5d0b431d63f1”,
“Asset Type”: “Person”,
“AssetControl”: “/asset/d13b7e51ec93/thumbnail.jpg”,
“Asset Context Data”: “http://en.wikipedia.org/wiki/Art_Arterton”,
“Time Start”: 15,
“Time End”: 22.5,
“Coordinates”: [ 0.35, 0.5 ]

}

Subroutine 600 ends in ending block 699, returning the time-line data received in block 615 to the caller.

FIG. 7 illustrates a subroutine 700 for serving contextual advertising metadata associated with a given video segment, such as may be performed by a video-platform server 200 in accordance with one embodiment.

In block 705, subroutine 700 receives a request from a remote playback device (e.g., media-playback device 105) for contextual metadata associated with a given video segment. For example, the remote playback device may, in the course of presenting a video or media presentation, request contextual or asset time-line data for an upcoming segment of the video (e.g., an upcoming 30 or 60 second segment). Typically, the request would include a video or media presentation identifier and a start time or time range.

In block 710, subroutine 700 retrieves time-line data for the requested segment of video from a data store (e.g., database 260). Typically, the retrieved asset time-line data includes a plurality of asset records, each describing an asset that is tagged as being depicted in or otherwise associated with the video segment.

In block 715, subroutine 700 provides to remote playback device the asset time-line data obtained in block 710. In some embodiments, some or all of the time-line data may be provided in a serialized format such as JavaScript Object Notation (“JSON”).

In block 720, subroutine 700 identifies assets that are depicted in or otherwise associated with the video segment. In many embodiments, subroutine 700 may identify such assets by parsing the asset time-line data obtained in block 710.

In block 723, subroutine 700 obtains video-match criteria (e.g., from database 260) associated with one or more previously-defined advertising campaigns.

In decision block 725, subroutine 700 determines whether the given video segment is associated with one or more advertising campaigns by determining whether the video or media presentation of which the given video segment is a part satisfies any of the video-match criteria obtained in block 723.

For example, in some embodiments, a video-match criterion for a given advertising campaign may identify a particular video or media presentation via a video identifier. In other embodiments, a video-match criterion for a given advertising campaign may identify a class of videos or media presentations by, for example, genre (e.g., comedy, drama, or the like), producer or distributor, production date or date range, or the like.

When subroutine 700 determines that the given video segment matches one or more advertising campaigns, subroutine 700 proceeds to opening loop block 730. If the given video segment does not match any advertising campaigns, then subroutine 700 skips to block 753.

Beginning in opening loop block 730, subroutine 700 processes each associated advertising campaign (as determined in decision block 725) in turn.

In block 735, subroutine 700 obtains (e.g., from database 260) asset-match criteria associated with the current advertising campaign.

In decision block 740, subroutine 700 determines whether one or more assets of the given video-segment (as identified in block 720) match one or more of the campaign asset-match criteria obtained in block 735. For example, in some embodiments, asset-match criteria may specify one or more specific assets (e.g., the asset having an ID of 12345). In other embodiments, asset-match criteria may specify one or more classes of asset (e.g., assets of type “Product:Clothing”).

When subroutine 700 determines that one or more assets of the given video-segment matches asset-match criteria of one or more advertising campaigns, subroutine 700 proceeds to block 745. Otherwise, subroutine 700 skips to ending loop block 750.

In block 745, subroutine 700 provides advertising campaign data to remote playback device. For example, in one embodiment, subroutine 700 may provide promotional data such as text, images, video, or other media (or links thereto) to be presented as an advertisement or promotion while the given video segment is rendered. In some embodiments, such promotional data may include a campaign identifier and an ad-server identifier identifying an ad sever or ad network that is responsible for providing promotional content to be presented while the given video segment is rendered.

In ending loop block 750, subroutine 700 iterates back to opening loop block 730 to process the next associated advertising campaign (as determined in decision block 725), if any.

In block 753, subroutine 700 obtains video-match criteria (e.g., from database 260) associated with one or more previously-defined asset-identification games.

In decision block 755, subroutine 700 determines whether the given video segment is associated with one or more asset-identification games by determining whether the video or media presentation of which the given video segment is a part satisfies any of the video-match criteria obtained in block 753.

If so, then subroutine 700 proceeds to block 760. Otherwise, subroutine 700 proceeds to ending block 799.

In block 760, subroutine 700 provides to the remote playback device a game specification corresponding to the asset-identification game(s) determined in decision block 755.

Subroutine 700 ends in ending block 799.

FIG. 8 illustrates an exemplary tagging user interface 800 for creating and/or editing asset tags associated with a video segment, such as may be provided by video-platform server 200 for use by a tag-editor device 115 in accordance with one embodiment.

In various embodiments, video-platform server 200 may provide HyperText Markup Language documents, Cascading Style Sheet documents, JavaScript documents, image and media files, and other similar resources to enable a remote tag-editing device (e.g., tag-editor device 115) to display and enable a user to interact with tagging user interface 800.

Tagging user interface 800 represents one possible user interface for for acquiring tags indicating temporal and spatial positions at which various assets are depicted in or otherwise associated with a given video or media presentation. Such a user interface may be employed in connection with manual editorial systems and/or crowd-sourced editorial systems. In other embodiments, tags may be acquired and/or edited via other suitable means, including via automatic object-identification systems, and/or a combination of automatic and editorial systems.

Asset selection controls 805A-H correspond to various assets that are likely to be depicted in or otherwise associated with the video presented in video pane 810. For example, in one embodiment, the list of asset selection controls may be pre-populated with assets corresponding to, for example, cast members, places, products, or the like that regularly appear in the video presented in video pane 810. In some embodiments, a user may also be able to add controls to the list as necessary (e.g., if an actor, place, product, or the like appears in only one or a few episodes of a series).

Video pane 810 displays a video or media presentation so that a user can tag assets that are depicted in or otherwise associated with various temporal and spatial portions of the video.

As illustrated, tag control 840 shows that the selected asset (Asset 4) appears towards the left side of the frame at the current temporal playback position of the video presented in video pane 810. In some embodiments, a user may be able to move, resize, add, and/or delete tag control 840 such that it corresponds to the temporal and spatial depiction of the selected asset during presentation of the video presented in video pane 810.

Using playback controls 815, a user can control the presentation of the video presented in video pane 810.

Asset tags summary pane 820 summarizes tags associated with a selected asset. As illustrated, asset tags summary pane 820 indicates that “Asset 4” (selected via asset selection control 805D) makes three appearances, for a total of one minute and 30 seconds, in the video presented in video pane 810. Asset tags summary pane 820 also indicates that “Asset 4” is tagged a total of 235 times in this and other videos.

Time-line control 825 depicts temporal portions of the video presented in video pane 810 during which the selected asset (Asset 4) is tagged as being depicted in or otherwise associated with the video presented in video pane 810. As illustrated, time-line control 825 indicates that the selected asset makes three appearances over the duration of the video, the second appearance being longer than the first and third appearances.

Tag thumbnail pane 835 presents tag “thumbnails” 830A-C providing an overview of the temporal and spatial locations in which the selected asset is tagged during a particular appearance. As illustrated, tag thumbnail pane 835 shows that during its first appearance, Asset 4 is tagged as appearing towards the left side of the frame during seconds 9-11 of minute two of the video presented in video pane 810.

Table 1, below, includes data representing several asset tags similar to those displayed in tag thumbnail pane 835. In various embodiments, such tag data may define regions within which various assets appear at various time points within a video. For example, in the tag data shown in Table 1, the asset with an asset_id of 4 is tagged within various regions (defined by center_x, center_y, width, and height, all of which are expressed as percentages of the dimensions of the video) at various points in time (defined by _position, which is expressed in seconds since the start of the video).

TABLE 1
Exemplary asset tag data

| video_id | tag_id | asset_id | center_y | center_x | width | height | start | end | _position |
|---|---|---|---|---|---|---|---|---|---|
| 3 | 464 | 4 | 26.25 | 40.21 | 9.14 | 16.25 | 0:02:09 | 0:02:10 | 129.0630 |
| 3 | 465 | 4 | 26.25 | 40.21 | 9.14 | 16.25 | 0:02:10 | 0:02:11 | 130.0634 |
| 3 | 466 | 4 | 26.25 | 40.21 | 9.14 | 16.25 | 0:02:11 | 0:02:12 | 131.2215 |
| 3 | 467 | 4 | 26.25 | 40.21 | 9.14 | 16.25 | 0:02:12 | 0:02:13 | 132.2219 |
| 3 | 468 | 4 | 26.25 | 40.21 | 9.14 | 16.25 | 0:02:13 | 0:02:14 | 133.2223 |
| 3 | 3967 | 4 | 95.21 | 1.39 | 22.78 | 39.58 | 0:02:14 | 0:02:15 | 134.1221 |
| 3 | 4146 | 12 | 45.21 | 69.03 | 10.83 | 16.25 | 0:02:14 | 0:02:15 | 134.2313 |
| 3 | 4147 | 12 | 45.21 | 69.03 | 10.83 | 16.25 | 0:02:15 | 0:02:16 | 135.0304 |
| 3 | 3968 | 4 | 95.21 | 1.39 | 22.78 | 39.58 | 0:02:15 | 0:02:16 | 135.6909 |
| 3 | 3969 | 4 | 95.21 | 1.39 | 22.78 | 39.58 | 0:02:16 | 0:02:17 | 136.1564 |
| 3 | 3970 | 4 | 95.21 | 1.39 | 22.78 | 39.58 | 0:02:17 | 0:02:18 | 137.1835 |
| 3 | 3971 | 4 | 95.21 | 1.39 | 22.78 | 39.58 | 0:02:18 | 0:02:19 | 138.1847 |

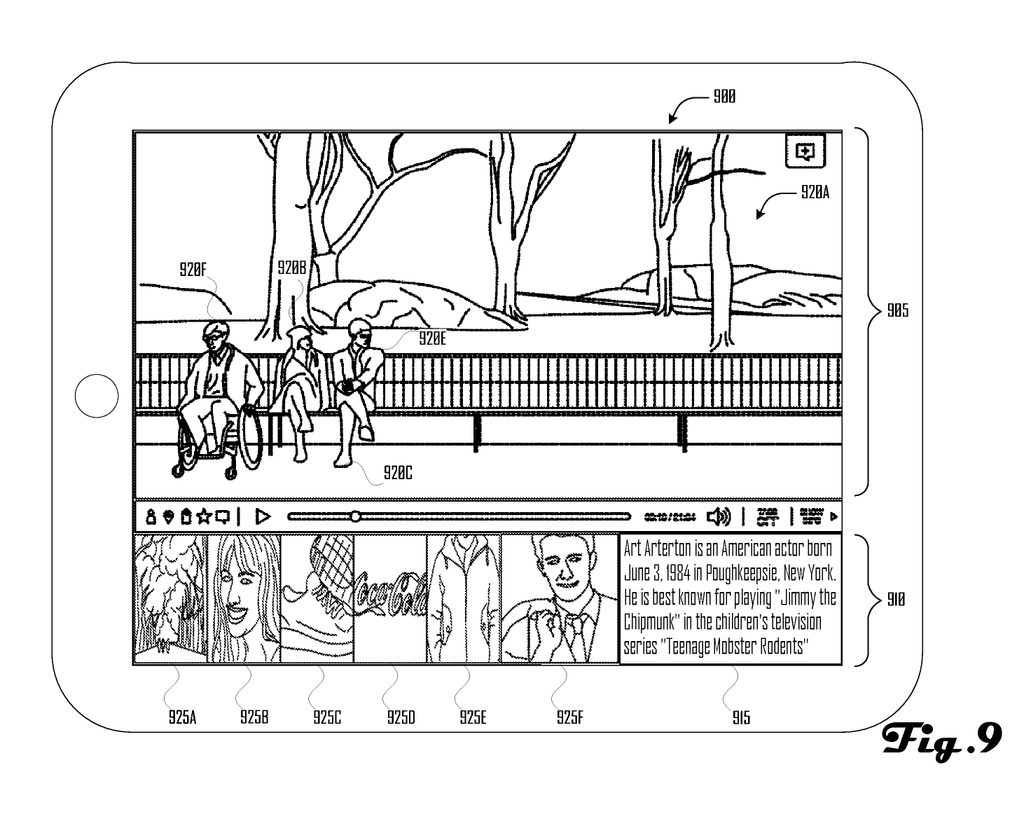

FIG. 9 illustrates an exemplary context-aware media-rendering user interface, such as may be provided by video-platform server 200 and generated by media-playback device 105 in accordance with one embodiment.

User interface 900 includes media-playback pane 905, in which renderable media data is rendered. The illustrated media content presents a scene in which three individuals are seated on or near a bench in a park-like setting. Although not apparent from the illustration, the individuals in the rendered scene may be considered for explanatory purposes to be discussing popular mass-market cola beverages.

User interface 900 also includes assets pane 910, in which currently-presented asset controls 925A-F are displayed. In particular, asset control 925A corresponds to location asset 920A (the park-like location in which the current scene takes place). Similarly, asset control 925B and asset control 925F correspond respectively to person asset 920B and person asset 920F (two of the individuals currently presented in the rendered scene); asset control 925C and asset control 925E correspond respectively to object asset 920C and object asset 920E (articles of clothing worn by an individual currently presented in the rendered scene); and asset control 925D corresponds to object asset 920D (the subject of a conversation taking place in the currently presented scene).

The illustrated media content also presents other elements (e.g., a park bench, a wheelchair, et al) that are not represented in assets pane 910, indicating that those elements may not be associated with any asset metadata.

Assets pane 910 has been configured to present context-data display 915. In various embodiments, such a configuration may be initiated if the user activates an asset control (e.g., asset control 925F) and/or selects an asset (e.g., person asset 920F) as displayed in media-playback pane 905. In some embodiments, context-data display 915 or a similar pane may be used to present promotional content while the video is rendered in media-playback pane 905.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A video-platform-server-implemented method for serving video-context-aware game metadata, the method comprising:
obtaining, by the video-platform server, asset time-line data comprising a plurality of asset identifiers corresponding respectively to a plurality of assets, namely persons, products, and/or places that are depicted during or otherwise associated with a video segment, said asset time-line data further specifying for each asset of said plurality of assets, at least one time range during which each asset is depicted or associated with said video segment;
storing, by the video-platform server, said asset time-line data in a data store;
receiving, by the video-platform server, a request from a remote playback device for contextual metadata associated with said video segment;
in response to receiving said request, retrieving, by the video-platform server, said asset time-line data from said data store;
providing, by the video-platform server, said asset time-line data to said remote playback device;
identifying, by the video-platform server according to said asset time-line data, said plurality of assets that are depicted during or otherwise associated with said video segment;
identifying, by the video-platform server from among a plurality of asset-identification game specifications, an asset-identification game specification specifying an asset-identification game associated with said video segment, said asset-identification game specification comprising one or more game video-matching criteria, game-rule data, and one or more game asset-matching criteria identifying a plurality of assets that may be selected to advance in said asset-identification game.

2. The method of claim 1, wherein obtaining said asset time-line data comprises:
determining a plurality of likely assets that are likely to be depicted during or otherwise associated with said video segment;
providing a user interface by which a remote operator can view said video segment and create and edit tags associating some of all of said plurality of likely assets with indicated spatial and temporal portions of said video segment; and
receiving said asset time-line data from said remote operator via said user interface.

3. The method of claim 1, further comprising identifying, from among a plurality of advertising campaign specifications, an advertising campaign specification specifying an advertising campaign associated with said video segment, said advertising campaign specification comprising one or more campaign video-matching criteria, one or more campaign asset-matching criteria, and promotional data.

4. A computing apparatus comprising a processor and a memory having stored thereon instructions that when executed by the processor, configure the apparatus to perform the method of claim 1.

5. A non-transient computer-readable storage medium having stored thereon instructions that when executed by a processor, configure the processor to perform a method for serving video-context-aware game metadata, the method comprising:
obtaining asset time-line data comprising a plurality of asset identifiers corresponding respectively to a plurality of assets, namely persons, products, and/or places that are depicted during or otherwise associated with a video segment, said asset time-line data further specifying for each asset of said plurality of assets, at least one time range during which each asset is depicted or associated with said video segment;
storing said asset time-line data in a data store;
receiving a request from a remote playback device for contextual metadata associated with said video segment;
in response to receiving said request, retrieving said asset time-line data from said data store;
providing said asset time-line data to said remote playback device;
identifying, according to said asset time-line data, said plurality of assets that are depicted during or otherwise associated with said video segment; identifying, from among a plurality of asset-identification game specifications, an asset-identification game specification specifying an asset-identification game associated with said video segment, said asset-identification game specification comprising one or more game video-matching criteria, game-rule data, and one or more game asset-matching criteria identifying a plurality of assets that may be selected to advance in said asset-identification game.

6. The storage medium of claim 5, wherein obtaining said asset time-line data comprises:
determining a plurality of likely assets that are likely to be depicted during or otherwise associated with said video segment;
providing a user interface by which a remote operator can view said video segment and create and edit tags associating some of all of said plurality of likely assets with indicated spatial and temporal portions of said video segment; and
receiving said asset time-line data from said remote operator via said user interface.

7. The storage medium of claim 5, the method further comprising identifying, from among a plurality of advertising campaign specifications, an advertising campaign specification specifying an advertising campaign associated with said video segment, said advertising campaign specification comprising one or more campaign video-matching criteria, one or more campaign asset-matching criteria, and promotional data.
